(19) United States
(12) Patent Application Publication
(10) Pub. No.: US 2016/0381049 A1
(43) Pub. Date: Dec. 29, 2016

(54) IDENTIFYING NETWORK INTRUSIONS AND ANALYTICAL INSIGHT INTO THE SAME

(71) Applicant: SS8 Networks, Inc., Milpitas, CA (US)

(72) Inventors: Faizel Zulfikar Lakhani, Campbell, CA (US); Rajdeep Singh Wadhwa, San Jose, CA (US); Kevin Joseph McTiernan, Castro Valley, CA (US); Nagendra Swamy Honnalagere Shivanna, San Jose, CA (US)

(21) Appl. No.: 14/751,581

(22) Filed: Jun. 26, 2015

(51) Int. Cl. H04L 29/06; G06F 17/30; G06F 17/27

(52) U.S. Cl. CPC H04L 63/1416; H04L 63/0236; H04L 63/1433; H04L 63/1425; G06F 17/2705; G06F 17/30424

(57) ABSTRACT

The present invention collects raw packet data related to network traffic flow over the course of time. By combining metadata from the application layer and/or session layer with user and device identity data as well as indicators of a network threat that are received from threat feeds, information concerning pre-existing or post-mortem network incidents may be identified. Based on the nature of a particular network threat and a collective history of network traffic flow over the course of time, analytics may allow for identification of compromised users, files, and network nodes. Such an identification may in turn allow for removal, rehabilitation, or further investigation.

### BACKGROUND OF THE INVENTION

Field of the Invention

The present invention generally concerns network security. More specifically, the present invention concerns identifying networks and systems that have suffered or that are in the process of suffering a compromising hack or intrusion and analyzing the scope and nature of that incident in order repair, rehabilitate, and inoculate the network against future incidents.

Description of the Related Art

Firewalls are network security systems that control incoming and outgoing network traffic based on applied rule sets. Firewalls may operate using packet filtering techniques. Packet filtering inspects packets communicated between computing devices on a network. If a packet coming from an unsecured or untrusted network (e.g., the Internet) fails to correspond to an applied rule set, the packet is dropped thereby preventing passage onto a trusted, secure internal network. Conversely, packets that match one or more filters may be allowed to pass from an unsecure network onto the secure network.

Firewalls may also operate up to the transport layer (layer 4) of the OSI model by retaining packets until enough information is available to make a judgment concerning state. These circuit-level gateways or “stateful firewalls” record all connections passing through the firewall and determine whether a packet is the start of a new connection, part of an existing connection, or not part of any connection. While static rules are still applied as in the case of packet filtering, connection state may now be utilized as a test criteria.

Firewalls may also utilize application layer filtering that understands certain applications and communication protocols (e.g., FTP, DNS, and HTTP). Application level filtering is useful in that is can detect whether an unwanted protocol is attempting to bypass the firewall on an otherwise allowed port. Application layer filtering also allows for deep packet inspection where the data and/or header of a packet is examined in a search for protocol non-compliance, viruses, spam, or other intrusions.

A multi-billion dollar network security industry has been built around firewall technologies. This industry engages in a never-ending effort to prevent network attacks and intrusions. Any number of companies in the network security industry tout scalability, third-party scanning engines, and policy-based management tools in conjunction with the aforementioned technologies as being critical to maintaining an internal network secure from unscrupulous outsiders looking to illicitly acquire information or to inflict maximum network damage and chaos.

What none of these network security companies will readily acknowledge is that notwithstanding their best technological efforts, network breaches will inevitably occur. Network security companies are loathe to acknowledge this inevitability as it is to otherwise admit to the fallibility of their particular firewall technologies.

There is a need in the art for a system and method that can identify network intrusions and offer analytical insights into the same. Such analysis includes the scope and nature of a given incident to allow for termination of the intrusion, repair and rehabilitation of the comprised network, and inoculating the network against future intrusions.

### BRIEF DESCRIPTION OF THE DRAWINGS

FIG. 1 illustrates a system for network intrusion insight.

FIG. 2 illustrates a method for network intrusion insight.

### SUMMARY OF THE CLAIMED INVENTION

A method for network intrusion insight is set forth in a first claimed embodiment of the present invention. The method involves parsing a network data flow at the application layer. Metadata associated with the application layer data is generated and enriched with user and device identity information. Threat intelligence ingested from a threat feed is used to analyze the enriched metadata to identify a network threat. Analytics corresponding to the identified network threat are displayed.

A further method for network intrusion insight is set forth in a second claimed embodiment. In the second claimed embodiment, a network dataflow is pared at the application layer whereby metadata associated with the network dataflow may be generated. The metadata is enriched with device and user identity data associated with the network data flow. The enriched metadata in stored in memory. A subsequent network data flow at the application layer that includes metadata and is enriched with user identity data associated with the subsequent network data flow is received. The enriched metadata is retrieved from memory whereby the enriched metadata, subsequent network data flow enriched with user identity data, and threat intelligence received from a threat feed are analyzed to identify a historical network threat. Analytics corresponding to the identified historical network threat are displayed.

A system for network intrusion insight is set forth in a third claimed embodiment of the present invention. A firewall is communicatively coupled to a network. Raw packet data is received from the network and parsed at the firewall. A sensor behind the firewall and on a secure portion of a network generates session metadata from the parsed packet data. User and device identity data is received at an analytics engine as is threat intelligence from a threat feed. The analytics engine applies the identity data and threat intelligence to the metadata. Information corresponding to a network threat and various analytics are generated and displayed.

### DETAILED DESCRIPTION

Embodiments of the present invention includes a system and method that can identify network intrusions and offer analytical insights into the same. Such analysis includes the scope and nature of a given incident to allow for termination of the intrusion, repair and rehabilitation of the comprised network, and inoculating the network against future intrusions. Network administrators can create user communication application records (UCAR) from packets and data records from every flow entering and leaving the network, store and analyze event records, and interact with data through visual analytics to aid in investigations, provide insights on security risks or offer other network context.

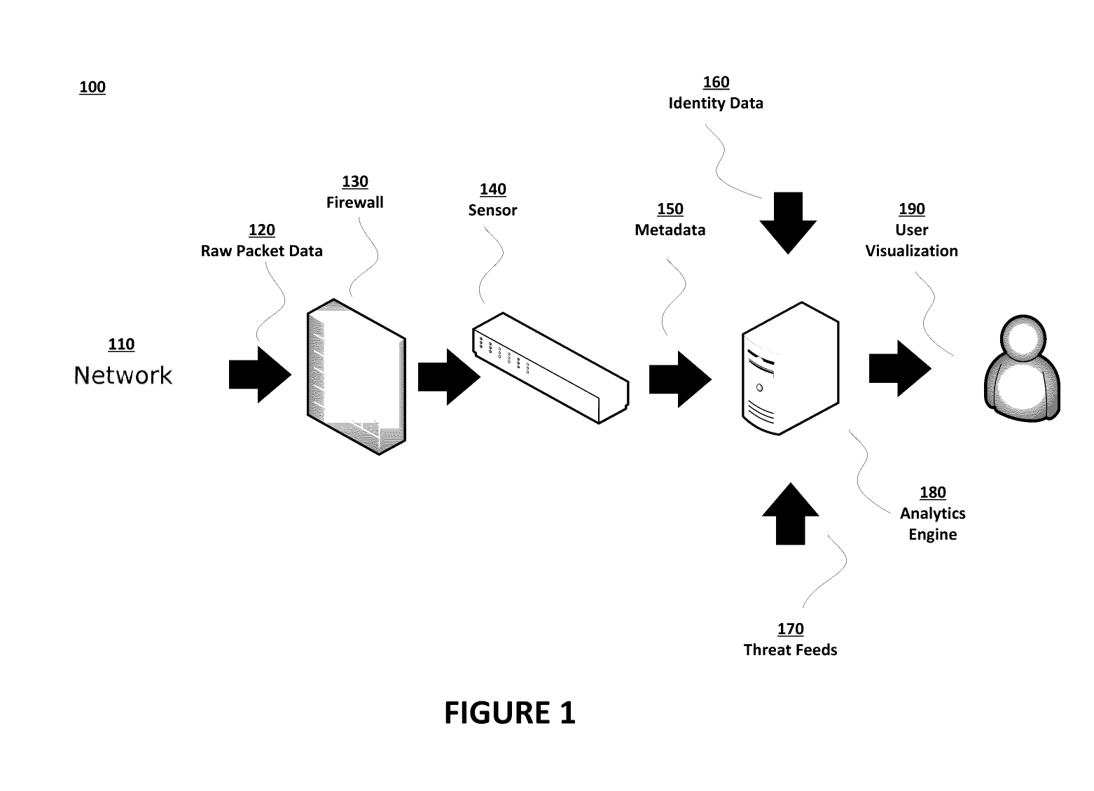

FIG. 1 illustrates a system 100 for network intrusion insight. The system 100 of FIG. 1 includes an unsecure network 110 such as the Internet. Raw packet data 120 is received over the network 110 at firewall 130. Raw packet data 120 is inclusive of data communications with any computing device not a part of a secure network and otherwise located behind the firewall 130. Raw packet data 120 is collectively representative of a network data flow, which may be received over the course of hours, days, months, or years.

Firewall 130 may include any commercially available network intrusion device and that otherwise allows for parsing of the raw packet data 120 from a network data flow. By parsing the raw packet data 120 in conjunction with the generation of metadata by sensor 140 (as further described herein), a network administrator may extract, collect, and generate data that allows for the tracking of advanced and slowly developing attacks and remote access tools. Insight into network activity—even non-malicious activity—may be reviewed and later studied.

Sensor 140 sits behind firewall 130 on a secure enterprise network. Sensor 140 seamlessly provides high-speed packet analysis and generates UCARs without otherwise interrupting day-to-day network services. Sensor 140 generates and provides metadata 150 to analytics engine 180. Sensor 140 may be positioned or otherwise configured at key locations on a secure enterprise network such as relative to critical document or information stores or with respect to particularly sensitive subsets of an otherwise protected network. Sensor 140 may be software, hardware, or a combination thereof including but not limited to executable instructions stored in a non-transitory computer readable storage medium and otherwise executed by a processing device.

Metadata 150 is created for all communications data. Metadata 150 correlates to session-level and/or application-level extraction in order to generate events at scale. Metadata 150 may be extracted using deep packet inspection techniques. Metadata 150 may include one or more of md5hash data, filenames, file-sizes, and subject information.

Analytics engine 180 also receives user and device identity data (160) related to network interactions as well as threat intelligence from one or more threat feeds (170). The analytics engine 180 applies the user and device identity data 160 and threat intelligence from the one or more threat feed 170 to the generated metadata 150 to identify a network threat. The analytics engine 180 monitors, stores, and ingests immutable structured traffic that is representative of a fraction of the space otherwise required to store source data, for example 0.01% or less. Analytics engine 180 allows for UCAR storage with real-time data enrichment and automatic enrichment between communications events and identity, device, and geographic destination. UCAR may be compressed at a ratio of 40:1 thereby allowing for months or years of retention and review.

In some instances, the analytics engine 180 may apply user and device identity data 160 and/or threat intelligent from the one or more threat feeds 170 against. UCAR or other historical data (versus real time data). Historical data may also be considered in the context of real-time data. Based on the nature of a particular network threat and a collective history of network traffic flow over the course of time, analytics performed by the analysis engine 180 may allow for identification of compromised users, files, and network nodes. Such an identification may in turn allow for removal, rehabilitation, or further investigation.

The use of historical data may be of particular relevance in the context of a pre-existing network vulnerability. Many network vulnerabilities may be related to a bug or flaw in coding that has long been present but unknown to a network administrator or device manufacturer. In such an instance, an otherwise secure enterprise (or believed to have been secured enterprise) may have long been the victim of the aforementioned vulnerability and prior to any threat intelligence having been provided with respect to the same. The present system 100 may use the historical information to analyze network behavior and potential exposure to intrusion or other compromising behavior once a threat feed 170 is updated to provide notice of the vulnerability or that said vulnerability is other discovered in its own right.

Device identity data 160 may include one or more of an Internet Protocol (IP) address, active directory userid, or other active directory userid. Device identity data 160 may also include dynamic host configuration protocol (DHCP) macid, GeoIP information, or domain name server (DNS) data for an IP address.

Threat intelligence 170 may be subscription based. These threat intelligence feeds alert subscribers about potential infections that have been found in one or more networks around the globe. Threat intelligence 170 is generally representative of network activity that poses a threat to the security infrastructure of an enterprise.

Threat intelligence 170 might include a definition of a network threat or threat signature. Threat intelligence 170 might otherwise include an indicator of compromise. Such indicators are inclusive of a list of md5s or sha1s of malicious binaries, a list of IP addresses that are known to spread malicious files, a list of websites that are hosting malware, or a list of behaviors that are indicative of data exfiltration. Indicators might also include includes a list of email addresses that “phish,” a list of email subject lines that are used to “phish,” a list of IP addresses of mail servers that are known to spread “phishing” email communications, or list of IP addresses of mail server that are known to spread malware. Indicators of compromise are also inclusive of lists of potential vulnerabilities or points of exploitation. These lists might correspond to an operating system. These lists might also correspond to a specific application.

Analytics engine 180 provides visual analytics and graphic representations of network activity to a network administrator 190. By graphically representing the data, the network administrator 190 or other network analyst may quickly filter and identify key communications, including communications or activity representative to a pre-existing or ongoing network incident such as a hack or other compromising activity. Visual analytical activity links various online identities to threats and creates an accessible and comprehensive portfolio of threat information.

The information presented to the network administrator 190 could include, but is not necessarily limited to, the existence of a threat or intrusion and the offending and/or victim systems information. System information, in turn, is inclusive of IP addresses, ports, users, device identifies, and other network enriching information such as DNS or GeoIP. From this information, the system administrator 190 might further analyze the communication events leading up to the threat or intrusion to identify a tactic or exploit that allowed for breach of the secure network. Once the means to breach the network is identified, it may be determined whether there are other breaches that lead to other intrusions or incidents of network compromise.

Some network intrusions may involve advanced persistent threats (APTs). An APT is generally recognized as a continuous and surreptitious computer hacking processes. APTs are typically orchestrated by third-parties targeting a specific entity such as a corporate enterprise or national government system. An APT may often be identified relative the communication means of command and control (C2 Communications). By creating a definition of C2 Communications in light of a prior or ongoing attack, the system 100 can identify those components of the network that may have been infected outside of the enterprise or where the infection bypassed internal enterprise protections such as a firewall 130.

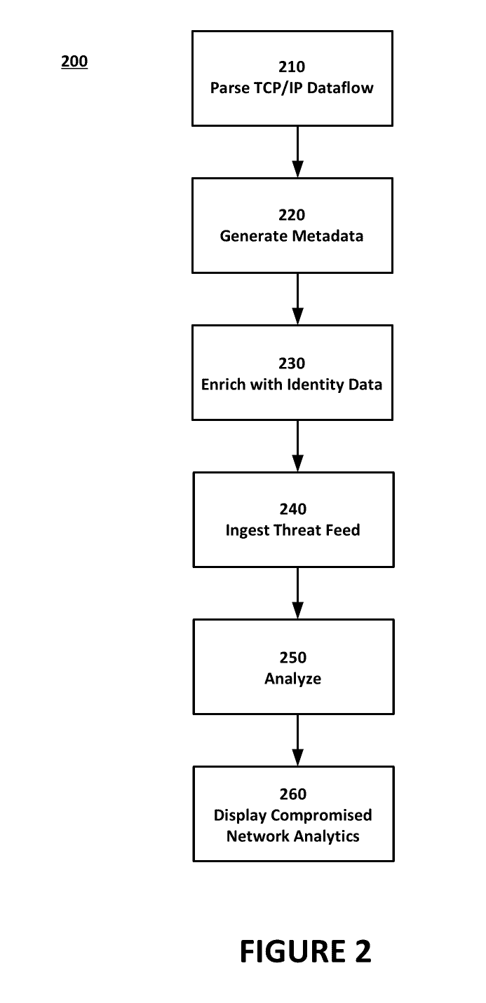

FIG. 2 illustrates a method 200 for network intrusion insight. The method 200 of FIG. 2 may be implemented in a system like that described in the context of FIG. 1 (100). This methodology (200) may operate in the context of any storage system, storage area network, network-attached storage device, or cloud or Hadoop service.

In step 210 of FIG. 2, a Transmission Control Protocol/Internet Protocol (TCP/IP) network data flow is parsed at the session and/or application layer. Step 210 of FIG. 2 generally correlates to the raw packet data 120 received from a network 110 at firewall 130 in FIG. 1.

Metadata is generated at step 220 of FIG. 2. The generated metadata is associated with the network dataflow parsed in step 210. Generation of metadata at step 220 might occur in the context of sensor 140 as discussed in FIG. 1 above. The generated metadata generally corresponds to metadata 150 of FIG. 1.

The metadata (150) as generated by sensor (140) following session and/or application layer network packet parsing at firewall (130) is then enriched at step 230 of FIG. 2. Enrichment of metadata (150) at step 230 occurs in the context of the analytics engine 180 of FIG. 1. Enrichment of metadata at step 230 includes the introduction of both device and user identity data (160) associated with the network data flow.

Analytics engine 180 also ingests network threat information (170). Ingestion of said information occurs at step 240 of FIG. 2. Analytics engine 180 analyzes the enriched metadata with threat intelligence ingested from a threat feed to identify a network threat at step 250. Analytics information corresponding to the network threat is then displayed at step 260.

The present invention may be implemented in the context of any variety of devices or enterprises. Non-transitory computer-readable storage media may be used to provide instructions to a central processing unit (CPU) for execution. Such media can take many forms, including, but not limited to, non-volatile and volatile media such as optical or magnetic disks and dynamic memory, respectively. Various forms of transmission media may be involved in carrying one or more sequences of one or more instructions to a CPU for execution. A bus may carry the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth above. Thus, the breadth and scope of any disclosed embodiment is intended to cover such alternatives, modifications, and equivalents as may be included within the spirit and scope of the invention as defined by the appended claims and otherwise appreciated by one of ordinary skill in the art.

What is claimed is:

1. A method for network intrusion insight, the method comprising:
parsing a network dataflow at the application layer;
generating metadata associated with the network dataflow;
enriching the metadata with device and user identity data associated with the network data flow;
ingesting threat intelligence received from a threat feed;
analyzing the enriched metadata with threat intelligence ingested from a threat feed to identify a network threat; and
visually displaying analytics information corresponding to the network threat.

2. The method of claim 1, wherein the metadata corresponds to the application layer.

3. The method of claim 1, wherein the metadata includes one or more of md5hash data, filenames, file-sizes, and subject information.

3. The method of claim 1, wherein the metadata is extracted using deep packet inspection.

4. The method of claim 1, wherein the threat feed includes an indicator of compromise.

5. The method of claim 1, wherein the threat feed includes a definition of a network threat or a threat signature.

6. The method of claim 4, wherein the indicator of compromise includes a list of md5s or sha1s of malicious binaries.

7. The method of claim 4, wherein the indicator of compromise includes a list of IP addresses that are known to spread malicious files.

8. The method of claim 4, wherein the indicator of compromise includes a list of websites that are hosting malware.

9. The method of claim 4, wherein the indicator of compromise includes a list of behaviors that are indicative of data exfiltration.

10. The method of claim 4, wherein the indicator of compromise includes a list of email addresses that “phish.”

11. The method of claim 4, wherein the indicator of compromise includes a list of email subject lines that are used to “phish.”

12. The method of claim 4, wherein the indicator of compromise includes a list of IP addresses of mail servers that are known to spread “phishing” email communications.

13. The method of claim 4, wherein the indicator of compromise includes a list of IP addresses of mail server that are known to spread malware.

14. The method of claim 4, wherein the indicator of compromise includes a list of vulnerabilities.

15. The method of claim 14, wherein the vulnerabilities correspond to an operating system.

16. The method of claim 14, wherein the vulnerabilities correspond to an application.

17. The method of claim 1, wherein the identity data includes one or more of an Internet Protocol (IP) address, active directory userid, dynamic host configuration protocol (DHCP) macid, GeoIP information, an active directory attribute other than an active director userid, and domain name server (DNS) data for an IP address.

18. A method for network intrusion insight, the method comprising:
parsing a network dataflow at the application layer;
generating metadata associated with the network dataflow;
enriching the metadata with device and user identity data associated with the network data flow;
storing the enriched metadata in memory;
receiving a subsequent network data flow at the application layer, wherein the subsequent network dataflow includes metadata and is enriched with user identity data associated with the subsequent network data flow;
retrieving the enriched metadata from memory;
analyzing the enriched metadata, subsequent network data flow enriched with user identity data, and threat intelligence received from a threat feed to identify a historical network threat; and
visually displaying analytics information corresponding to the historical network threat.

19. The method of claim 18, wherein the historical network threat identifies one or more compromised users, files, or network nodes.

20. A system for network intrusion insight, the system comprising:
a firewall that parses raw packet data received from a network;
a sensor located on a secure portion of a network and behind the firewall that generates session metadata from the parsed packet data; and
an analytics engine that receives both user and device identity data and threat intelligence from a threat feed, wherein the analytics engine applies the user and device identity data and threat intelligence to the session metadata to identify a network threat, information corresponding to the network threat and various analytics displayed in response to identification of the same.
